(19) United States
(12) Patent Application Publication
(10) Pub. No.: US 2011/0294614 A1
(43) Pub. Date: Dec. 1, 2011

(54) BELT TENSIONING SYSTEM

(76) Inventor: Jeremy M. Bigler, Landisville, PA (US)

(21) Appl. No.: 13/150,882

(22) Filed: Jun. 1, 2011

Related U.S. Application Data
(60) Provisional application No. 61/350,404, filed on Jun. 1, 2010.

(51) Int. Cl. F16H 7/12; B23P 11/00

(52) U.S. Cl. 474/133; 29/428

(57) ABSTRACT

A system for improving the efficiency of a belt-driven system is provided. The system is particularly adapted for retrofitting tensioners onto existing belt-driven machines or to incorporate a tensioner into an the existing design of a belt-driven machine with limited changes to the specifications of the existing design. The system includes a motor driving a belt that drives a pulley. The pulley drives a shaft or other element of the system. A tensioner is provided for tensioning the belt to impede slippage between the belt and the pulley. The tensioner is connected to the motor and a frame of the system via a mounting bracket that includes a first leg and a second leg having a plurality of mounting holes adapted to cooperate with mounts on the motor and a connector of the tensioner. In one embodiment, the mounting holes of the second leg are laterally offset from one or more mounting holes of the first leg. Additionally, in one embodiment, the mounting bracket is configured so that the mounting holes in the first leg are positioned to form an array of rows and columns, and the mounting holes in the second leg are positioned to form a separate array of rows and columns.

### RELATED APPLICATION

This application claims priority under 35 U.S.C. §119 to U.S. Provisional Patent Application No. 61/350,404 filed Jun. 1, 2010. The entire disclosure of the foregoing application is hereby incorporated by reference.

### FIELD OF THE INVENTION

The present invention relates to the field of tensioners. More particularly, the present invention relates to the field of systems for tensioning a belt.

### BACKGROUND

A variety of mechanical systems are driven by an endless belt, such as a v-belt that is driven by a motor. During use, the belt frequently elongates and may start to slip. As the belt slips, the efficiency of the power transferred from the motor reduces, reducing the overall efficiency of the system. Various improvements have been attempted to reduce the power inefficiency from belt slippage. For instance, in one system, the belt and pulleys are replaced with toothed belts driven by toothed pulley. Although such systems may improve the power transfer in some instances, such a system is susceptible to complications from deflection of the various elements during use. Accordingly, there is a need for a low-cost reliable system for improving the overall efficiency of a belt-driven system by reducing belt slippage.

### SUMMARY OF THE INVENTION

The present system provides a system for improving the efficiency of a belt-driven system. The system includes a motor driving a drive pulley and a belt entrained about the drive pulley and a driven pulley. The driven pulley is connected to an output, such as a ventilation fan. A tensioning device engages the drive belt to provide continuous tension on the belt. The tensioner is mounted to a bracket connected with the motor. The mounting bracket includes a first leg for forming a connection with the motor. The first leg is formed to provide an adjustable connection between the mounting bracket and a mounting bracket of the motor. The first leg has an array of mounting slots arranged into rows along the length of the first leg and columns across the width of the first leg. In one embodiment, the slots are elongated along the direction of the rows. The mounting bracket further comprises a second leg projecting transverse the first leg. The second leg comprises a plurality of slots for connecting the tensioner to the mounting bracket. In one embodiment, the slots form an array of rows and columns and the slots are elongated in a direction transverse the direction in which the slots in the first leg are elongated.

The present system also includes a method for improving the efficiency of a belt-driven system. The method includes the steps of fitting a belt tensioner into an existing belt driven system that includes a motor connected to the system by a plurality of detachable connectors engaging the motor mount and a frame of the system. According to the method, a mounting bracket is provided, which has a first leg having a plurality of slots. At least one of the connectors is disconnected from the motor mount and the frame, and the first leg of the bracket is interposed between the motor mount and the frame or the connector. The connector is then reconnected thereby attaching the first leg of the bracket to the motor mount. The mounting bracket further comprises a second leg projecting transverse the first leg and having a plurality of mounting slots. The method includes the step of connecting a tensioner with the second leg of the mounting bracket so that an arm of the tensioner projects into engagement with the drive belt, and rotating the arm to bias the tensioner to provide tension to the drive belt.

### DESCRIPTION OF THE DRAWINGS

The foregoing summary and the following detailed description of the preferred embodiments of the present invention will be best understood when read in conjunction with the appended drawings, in which:

FIG. 1 is a perspective view of a belt tensioning system;

FIG. 2 is a side view of the belt tensioning system of FIG. 1;

FIG. 3 is a front elevational view of an alternate belt tensioning system;

FIG. 4 is a perspective view of a mounting bracket of the belt tensioning system of FIGS. 1-3;

FIG. 5 is a plan view of the mounting bracket illustrated in FIG. 4; and

FIG. 6 is a front view of the mounting bracket illustrated in FIG. 4.

### DETAILED DESCRIPTION OF THE INVENTION

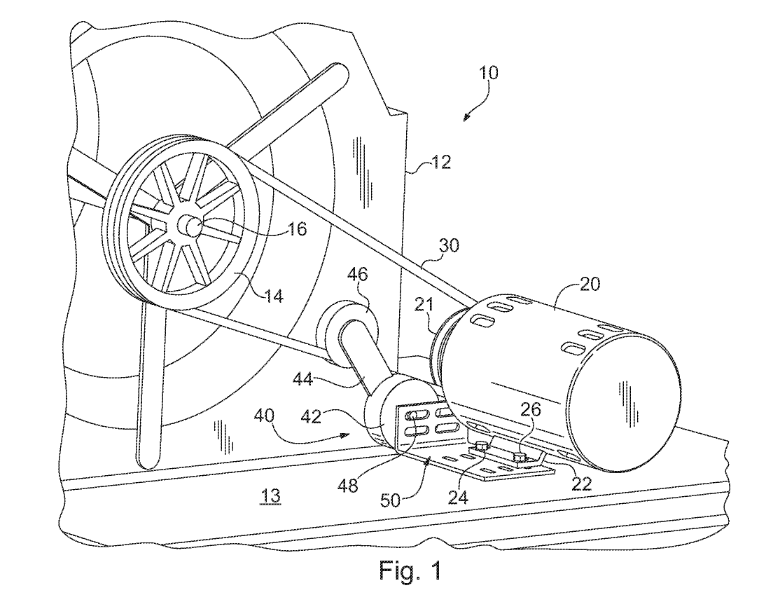

Referring now to the figures in general and to FIG. 1 specifically, a belt driven system is generally designated 10. A motor 20 drives a belt 30, which rotates a pulley 14. The pulley 14 is connected with an output shaft 16, so that when the pulley 14 rotates, the output shaft also rotates. A tensioner 40 engages the belt to tension the belt, thereby limiting slippage between the belt and either of the pulleys 14 and 21.

The system 10 may be any of a variety of belt-driven machines. However, in the present instance, the system is an HVAC system and the output shaft drives a fan, such as a ventilation fan, or a chiller. The pulley 16 is rigidly connected with the output shaft, such as by a key or by a keyless connection, such as a mounting device sold under the trademark Tran Torque by Fenner, Inc. in Manheim, Pa. An exemplary keyless connector for mounting the pulley to the shaft is disclosed in U.S. Pat. No. 5,695,297.

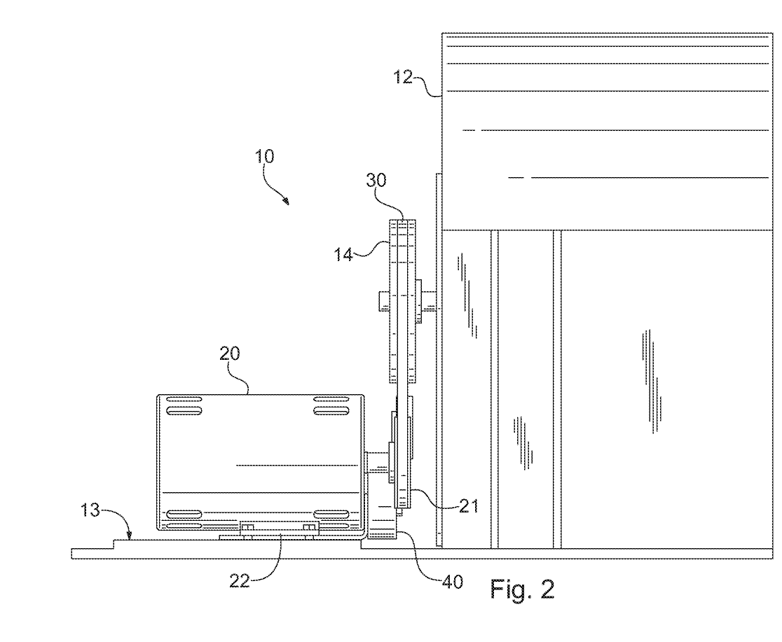

The system includes a frame 12, which may include a base plate 13 as shown in FIG. 1. The motor 20 is rigidly mounted to the base plate. In the present instance, the motor 20 includes a mount 22 in the form of a foot that projects away from the body of the motor. Additionally, as shown in FIG. 2, in the present instance, the mount 22 includes a similarly configured second foot projecting from the motor, spaced apart from the first foot. Each foot of the motor mount 22 includes a pair of holes for mounting the motor to the frame 12. The holes may be circular apertures, such as bolt holes. However, in the present instance, the mounting holes are elongated slots that are elongated along the axis of the motor (i.e. along an axis parallel to the axis of rotation of the drive pulley 21 connected to the motor). The motor 20 is connected to the frame 12 by a plurality of connectors 24, 26. In the present instance, the connectors are releasable connectors, such as bolts. The connectors 24, 26 extend through the slots in the motor mount and are connected with the frame. For instance, the frame 12 may include a plurality of threaded bolt holes into which the bolts 24, 26 are threaded to connect the motor to the frame. Alternatively, other connectors, such as threaded nuts may be used to connect the connectors 24, 26 to the frame.

The motor 20 drives a shaft to which a drive pulley 21 is connected. The belt 30 in entrained around the drive pulley 21 and the driven pulley 14. The tensioner 40 is mounted adjacent the motor so that the tensioner engages a run of the belt to tension the belt, thereby taking up slack in the belt.

The tensioner 40 comprises a housing 42 that houses a biasing element, such as a spring. The biasing element may be a coil spring or a flat wrap torsion spring. The biasing element biases an arm 44 that is connected with the housing. The arm 44 is pivotable about a central axis of the tensioner so that the arm is pivotable toward or away from the belt. The central axis of the tensioner is substantially parallel to the central axis of the output shaft of the motor 20. A tensioner pulley 46 is connected to the arm 44 remote from the housing. The tensioner pulley 46 is rotatable relative to the arm 44 and engages the belt. A connector 48, such as a mounting bolt, extends through the housing 42 to connect the tensioner 40 to the mounting bracket 50.

The mounting bracket 50 is connectable with both the tensioner 40 and the motor 20 to mount the tensioner to the system 10. In the present instance, the mounting bracket 50 is interposed between the motor mount 22 and the frame 12 and is configured to position the tensioner pulley 46 in operative engagement with the belt 30.

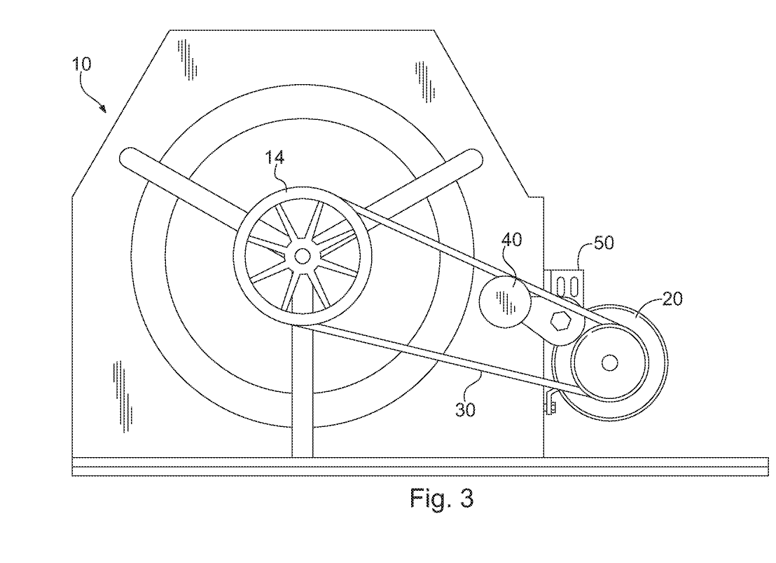

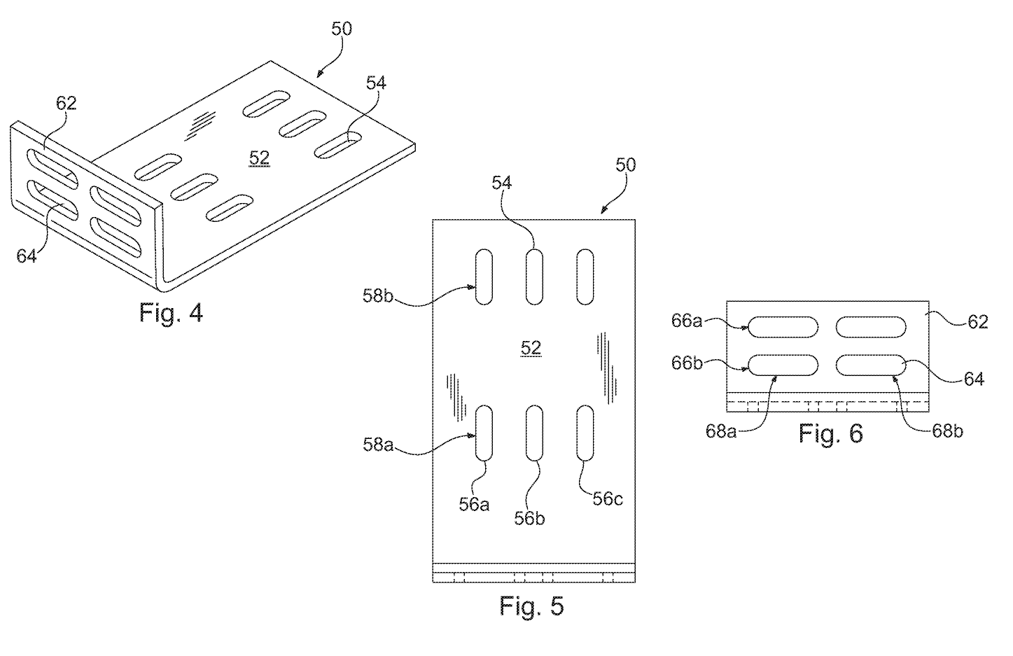

Referring to FIG. 4, the mounting bracket 50 will be described in greater detail. The mounting bracket 50 includes a first leg 52 that is a generally flat planar portion. The first leg has a length that is approximately 1.5 to 4 times as long as its width. In the present instance, the length is approximately 1.75 times as long as the width. The first leg includes a plurality of mounting holes 54 spaced apart from one another on the first leg. In the present instance, the mounting holes 54 are elongated slots that are sufficiently large to allow the motor connectors 24, 26 to extend through the first leg of the mounting bracket. The slots 54 are elongated along the length of the first leg, and in the present instance are elongated so that the length of the slot is at least approximately twice the width of the slot.

As shown in FIG. 4, the slots 54 may be aligned to form rows 56 of slots. More specifically, as shown in FIG. 4, the first leg may include three rows of slots. In the first row, two slots 54 are aligned along the length of the first leg to for row 56a. Similarly, two more rows of slots 56b and 56c are formed generally parallel to the first row 56a. Additionally, as shown in FIG. 4, the slots may be arranged in the rows so that the slots form columns 58. For instance, as shown in FIG. 4, the first slot in each of rows 56a, 56b, 56c are aligned to form column 58a. Similarly, the second slot in each of rows 56a, 56b, 56c are aligned to form column 58b. As can be seen from the foregoing, the rows and columns are positioned to provide an array of mounting slots that can be used to mount the bracket to the motor 20. In the present instance, the array is formed so that the columns are spaced apart approximately twice as far as the distance between rows. Additionally, the array is positioned so that the rearward end of the slots in the forward column 58a are spaced apart from the second leg 62 so that the distance from the rearward end of the slots in the forward column to the second leg is at least almost as long as the distance from the rearward end of the slots in the forward column 58a to the rearward edge of the first leg. For instance, in the present instance the first leg is approximately 6.8″ long and the distance from the rearward end of the forward slots 58a to the second leg 62 is approximately 3.4″.

The second leg 62 of the mounting bracket 50 projects upwardly from the first leg 52, transverse the first leg to form an L-shaped bracket. The second leg 62 may be wider than it is high. For instance, in the present instance, the bracket is approximately twice as wide as it is high.

The second leg also includes a plurality of mounting holes 64 through the bracket. In the present instance, the holes are elongated to form slots, and in the present instance, the slots are elongated in the direction of the width of the second leg. The slots 64 are aligned so that a slot in the second leg is offset from one of the rows of slots 54 in the first leg. For instance, in the embodiment illustrated in FIG. 4, the second leg includes four spaced apart slots that are positioned to form an array of two rows 66a, 66b of two columns 68a, 68b. As shown in FIGS. 4-6, the first column 68a of slots in the second leg 62 is offset from the third row of slots 56c in the first leg 52. Similarly, the second column 68b of slots in the second leg 62 is offset from the first row of slots 56a in the first leg.

Configured as described above, the mounting bracket provides a widely adaptable structure for incorporating a tensioner into a belt-drive system to improve the efficiency of the system. Further still, the configuration of the bracket is particularly suited for either retrofitting a tensioner into belt-drive systems that are already installed in the field or into existing OEM belt-drive configurations with minimal or no changes to the OEM specifications for the system. Accordingly, as described below, the present system provides a method for retrofitting an existing belt-drive system to incorporate a tensioner.

In an existing system 10, the motor 20 is connected to the frame 12 via four connectors connecting to the motor mounts 22, as described previously. Two of the connectors 24, 26 are disconnected from the frame 12 to disconnect one of the motor mounts 22 from the frame. The first leg 52 of the mounting bracket 50 is positioned to align two of the mounting slots from one of the rows (58a in FIG. 1) with the mounting holes in the frame and the motor mount 22. In the present instance, the first leg 52 is interposed between the frame 12 and the motor mount 22, however, it may be desirable to attach the first leg above the motor mount. In either instance, after the row of slots are aligned with the motor mount holes 22 and the holes in the frame 12, the connectors 24, 26 are inserted into the aligned holes to attach the bracket with the motor and the frame.

Additionally, in the previous description, the frame 12 is described as having mounting holes for receiving the connectors 24, 26 for mounting the motor and the bracket 50 to the frame. In some instances, the frame may incorporate elongated slots or channels, for connecting the motor to the frame. For example, the frame may incorporate parallel elongated slots, such as T-slots for connecting the motor to the frame. Accordingly, it should be understood that the term holes incorporates a variety of structures, including, but not limited to slots, channels, apertures and threaded openings.

The tensioner is connected with the second leg 62 of the mounting bracket 50 to position the tensioner adjacent the belt 30. Although the tensioner can be connected to the second leg before connecting the first leg with the motor, in the present instance, the tensioner 40 is connected with the second leg after the first leg is connected with the motor and the frame.

The tensioner 40 is connected to the second leg by inserting a connector through one of the mounting slots 64 of the second leg and fixing the connector to the second leg. The tensioner connector 48 is extended through a mounting slot in the second leg of the mounting bracket which may be offset from the mounting slot connecting the first leg 52 with the motor 20. For example, in the present instance, a mounting bolt 48 extends through the tensioner housing 42 and the slot 64 in the second row 68b of the second leg 62. A threaded nut (not shown) is threaded onto the end of the mounting bolt to attach the tensioner to the bracket. The connector is tightened sufficiently to substantially impede movement of a base of the tensioner housing 42 relative to the mounting bracket. The tensioner arm 44 is displaceable relative to the base that is fixed relative to the second leg 62 of the mounting bracket. In this way, rotating the tensioner arm 44 relative of the bracket increases the biasing force of the biasing element acting on the arm of the tensioner. The tensioner pulley is then moved into engagement with the belt 30 so that the pulley provides a tensioning force against the belt.

Referring to FIG. 3, an alternate configuration of mounting the tensioner 40 onto the system 10 is illustrated. In the alternate embodiment, the tensioner is mounted so that the mounting bracket 50 is generally vertical. The third row of mounting slots 56c are aligned with the holes in the mounting bracket 22 on the motor and mounting holes in a vertical wall of the frame 12. The tensioner 40 is then connected to one of the slots 64 in the second row 64b of the second leg of the mounting bracket.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A system for improving the efficiency of a belt-driven system, comprising:
a motor having a drive pulley;
a driven pulley spaced apart from the drive pulley;
a belt entrained about the drive pulley and a driven pulley;
a tensioner engages the drive belt to provide continuous tension on the belt;
a bracket connected with the motor and the tensioner, wherein the mounting bracket comprises:
a first leg for forming a connection with the motor, wherein the first leg comprises an array of mounting holes arranged into rows along the length of the first leg and columns across the width of the first leg; and
a second leg projecting transverse the first leg, wherein the second leg is connected with the first leg and comprises a second array of mounting holes arranged into rows along the width of the second leg and columns along the height of the second leg.

2. The system of claim 1 wherein the mounting holes in the first leg are elongated slots that are elongated along the direction of the length of the first leg.

3. The system of claim 2 wherein the mounting holes of the second leg are elongated slots that are elongated in a direction transverse the direction in which the slots in the first leg are elongated.

4. The system of claim 3 wherein the mounting holes of the second leg are elongated along the width of the second leg.

5. The system of claim 1 wherein the motor has an output shaft having an axis of rotation, wherein the mounting holes in the first leg are elongated along a direction substantially parallel to the axis of rotation.

6. The system of claim 1 wherein the tensioner has an axis of rotation wherein the mounting holes in the first leg are elongated along a direction substantially parallel to the tensioner axis of rotation.

7. A method for improving the efficiency of a belt-driven system, comprising the steps of:
providing a belt driven system that includes a motor having a motor mount connected to a frame by a plurality of detachable connectors engaging the motor mount and the frame;
providing a mounting bracket having a first leg having a plurality of slots and a second leg projecting transverse the first leg and having a plurality of mounting slots;
disconnecting a pair of the detachable connectors from the motor mount and the frame;
interposing the first leg of the bracket between the motor mount and the frame or the connector;
aligning a pair of mounting holes of the first leg with mounting holes in the motor mount and the frame;
reconnecting the detachable connectors to the frame, thereby attaching the first leg of the bracket to the motor mount;
connecting a tensioner with the second leg of the mounting bracket so that an arm of the tensioner projects into engagement with the drive belt, and
rotating the arm to bias the tensioner to provide tension to the drive belt.

8. The method of claim 7 wherein the motor comprises an output shaft having an axis of rotation and the first leg of the mounting bracket comprises an aligned row of mounting holes, wherein the method comprises the step of orienting the row of mounting holes so that the row is substantially parallel with the axis of rotation.

9. The method of claim 7 wherein the tensioner comprises an arm pivotable about a pivot axis and the first leg of the mounting bracket comprises an aligned row of mounting holes, wherein the method comprises the step of orienting the row of mounting holes so that the row is substantially parallel with the pivot axis.
